(19) United States
(12) Patent Application Publication
(10) Pub. No.: US 2025/0209055 A1
(43) Pub. Date: Jun. 26, 2025

(54) STORING OF DATA MADE TAMPER-EVIDENT ACCORDING TO CORRESPONDING CERTIFIED CONSISTENCY PROOFS

(71) Applicant: Traent S.r.l., Milano (IT)

(72) Inventors: Fabio SEVERINO, Pisa (IT); Claudio FELICIOLI, Pisa (IT); Andrea CANCIANI, Pisa (IT)

(73) Assignee: Traent S.r.l., Milano (IT)

(21) Appl. No.: 18/842,720

(22) PCT Filed: Feb. 27, 2023
(86) PCT No.: PCT/EP2023/054798

§ 371 Date: Aug. 29, 2024

(30) Foreign Application Priority Data
Mar. 1, 2022 (IT) 102022000003839

(51) Int. Cl. G06F 16/23

(52) U.S. Cl. CPC G06F 16/2365

(57) ABSTRACT

A solution is proposed for storing tamper-evident data in data structures each containing a persistent sequence of data blocks. A certification computing system (115) stores (408,425) current digests of current versions of the data structures. Storage computing systems (105) submit (418-421) appending requests to the certification computing system (115), each comprising an indication of a new digest of a new version of a data structure with a new data block appended thereto and a consistency proof of the new version with respect to the current version of the data structure. The certification computing system (115) generates (423-428) corresponding appending receipts in response to a positive result of a verification of the appending requests. Moreover, software programs (340-355;305-335) and software program products for execution on the certification computing system (115) and on each storage computing system (105), respectively, are also proposed. A certification computing system (115), a storage computing system (105) and a computing infrastructure (200) comprising them are also proposed.

### TECHNICAL FIELD

The present disclosure relates to the information technology field. More specifically, this disclosure relates to the storing of data.

### BACKGROUND

The background of the present disclosure is hereinafter introduced with the discussion of techniques relating to its context. However, even when this discussion refers to documents, acts, artifacts and the like, it does not suggest or represent that the discussed techniques are part of the prior art or are common general knowledge in the field relevant to the present disclosure.

Storing of data is a commonplace activity in most computing systems (for example, for their preservation, outputting, further processing and so on). In several situations, the storing of data is subject to specific requirements.

Particularly, it may be required that the storing of data is persistent; this means that it should not be possible to alter the data once they have been stored. Therefore, any updates of the data should preserve all previous versions of the same data; this requirement may be fulfilled in a general way by organizing the data in a sequence of (data) blocks and then restricting the writing by allowing only the append of each new block to an end of the sequence. For this purpose, it may be important that the data being stored is tamper-evident. This means that any alteration of the data after their storing should be detectable in a relatively easy way. All of the above allows making the data non-repudiable, so that their validity may not be denied. This is important in situations wherein integrity and origin of the data have to be trusted by different subjects.

Moreover, it may be required that access to the data is controlled. This means that access to the data should be restricted selectively to specific subjects only. All of the above allows avoiding disclosure of the data to unauthorized subjects that are not entitled to know them. This is important in situations wherein the data have not to be disseminated publicly.

For this purpose, a central entity that is generally trusted by all the involved subjects may be delegated to store the data. The central entity guarantees that the data are persistent and that they may be accessed only by authorized subjects. However, this requires uploading all the data to be stored to a (central) server of the central entity. The uploading of the data may involve an overloading of a network being used to communicate with the central server (especially in case of uploading of large amount of data). All of the above may involve a corresponding performance degradation. In any case, the uploading of the data to the central server may be unfeasible; a typical example is when the data are subject to strict confidentiality requirements.

Alternatively, the data may be stored into a blockchain. The blockchain is a distributed ledger that stores data into a sequence of blocks in chronological order, linked to each other via corresponding hash values. The blockchain is distributed throughout peer nodes of a corresponding network, which validate its content according to a consensus schema that determines the valid version of the blockchain (with no centralized version of the blockchain that exists and no node that is more trusted than any other node is). In a consensus schema based on a proof of work, a complex mathematical problem has to be solved by determining a nonce to be added to each block that provides a specific property of its hash value. Therefore, no block may be altered without re-determining the nonces of this block and of all the next blocks in the blockchain; however, the difficulty of the mathematical problem required to determine the nonces makes it substantially impossible to alter the blockchain (unless a majority of the processing power of the whole network is acquired). Particularly, in a blockchain of permissionless (or public) type, no restriction exists on its access. Conversely, in a blockchain of permissioned (or private) type, the blockchain may not be joined unless invited by an owner thereof. The owner may then limit access to the (private) blockchain to authorized subjects only.

However, the blockchain requires a relatively large network to ensure an acceptable degree of reliability (especially when it is public). The solutions of the mathematical problem required for appending new blocks involve a high consumption of computational resources and then of energy. The consensus schema requires all the nodes to consume networking, computational and storage resources for every block that is added to the blockchain; this may be quite ineffective for nodes that are interested only in a relatively small amount of the data contained in the blockchain. Particularly, in case of a private blockchain (to control access to the data), persistency of the data may not be verified in case they are provided outside the corresponding network or persistency of pre-existing data may not be verified by new subjects invited to join the blockchain later on.

Document “Improving Authenticated Dynamic Dictionaries, with Applications to Cryptocurrencies” by L. Reyzin et al., 21st International Conference on Financial Cryptography and Data Security, April 2017 describes an authenticated dynamic dictionary for verifying transactions performed on a blockchain implementing a cryptocurrency. Miners hold the blockchain and an entire dynamic dictionary (maintaining balances of all accounts of the blockchain) whereas verifiers hold a digest of the dynamic dictionary. Each miner performing a block of transactions on the blockchain (and corresponding updates of the dynamic dictionary involving insertion of accounts, update of balances and/or deletion of accounts) publishes the transactions, a proof of the corresponding updates of the dynamic dictionary and a new digest of the dynamic dictionary. Each verifier uses the proof to verify the updates of the dynamic dictionary with respect to its digest and that the new digest is correct. However, the dynamic dictionary that is verified is not a persistent data structure and the miners need to publish the updates of the dynamic dictionary to allow their verification; moreover, a large number of verifiers is needed for the health of the cryptocurrency (since no entity is trusted in the corresponding network of the blockchain having no central authority), with them that only verify the updates of the dynamic dictionary corresponding to the transactions after they have already been performed by the miners.

### SUMMARY

A simplified summary of the present disclosure is herein presented in order to provide a basic understanding thereof; however, the sole purpose of this summary is to introduce some concepts of the disclosure in a simplified form as a prelude to its following more detailed description, and it is not to be interpreted as an identification of its key elements nor as a delineation of its scope.

In general terms, the present disclosure is based on the idea of making data tamper-evident according to corresponding certified consistency proofs.

Particularly, an aspect provides a method for certifying storing of tamper-evident data in data structures. A certification computing system stores current digests of current versions of the data structures. The certification computing system receives an appending request comprising an indication of a new digest of a new version of a data structure with a new data block appended thereto and a consistency proof of the new version with respect to the current version of the data structure. The certification computing system generates an appending receipt in response to a positive result of a verification of the appending request.

A further aspect provides a corresponding method for storing tamper-evident data by a storage computing system. The method comprises submitting the appending request to the certification computing system, receiving the corresponding appending receipt and appending the new data block in association with the corresponding appending receipt to the data structure in response thereto.

A further aspect provides a corresponding method with steps performed by the certification computing system and the storage computing system.

A further aspect provides a software program for implementing each of the methods.

A further aspect provides a corresponding software program product.

A further aspect provides a certification computing system for performing the corresponding method.

A further aspect provides a storage computing system for performing the corresponding method.

A further aspect provides a computing infrastructure comprising the certification computing system and one or more storage computing systems.

More specifically, one or more aspects of the present disclosure are set out in the independent claims and advantageous features thereof are set out in the dependent claims, with the wording of all the claims that is herein incorporated verbatim by reference (with any advantageous feature provided with reference to any specific aspect that applies mutatis mutandis to every other aspect).

### BRIEF DESCRIPTION OF THE DRAWINGS

The solution of the present disclosure, as well as further features and the advantages thereof, will be best understood with reference to the following detailed description thereof, given purely by way of a non-restrictive indication, to be read in conjunction with the accompanying drawings (wherein, for the sake of simplicity, corresponding elements are denoted with equal or similar references and their explanation is not repeated, and the name of each entity is generally used to denote both its type and its attributes, like value, content and representation). Particularly:

FIG. 1A-FIG. 1D show the general principles of the solution according to an embodiment of the present disclosure,

FIG. 2 shows a schematic block diagram of a computing infrastructure that may be used to implement the solution according to an embodiment of the present disclosure,

FIG. 3 shows the main software components that may be used to implement the solution according to an embodiment of the present disclosure, and

FIG. 4A-FIG. 4D show an activity diagram describing the flow of activities relating to an implementation of the solution according to an embodiment of the present disclosure.

### DETAILED DESCRIPTION

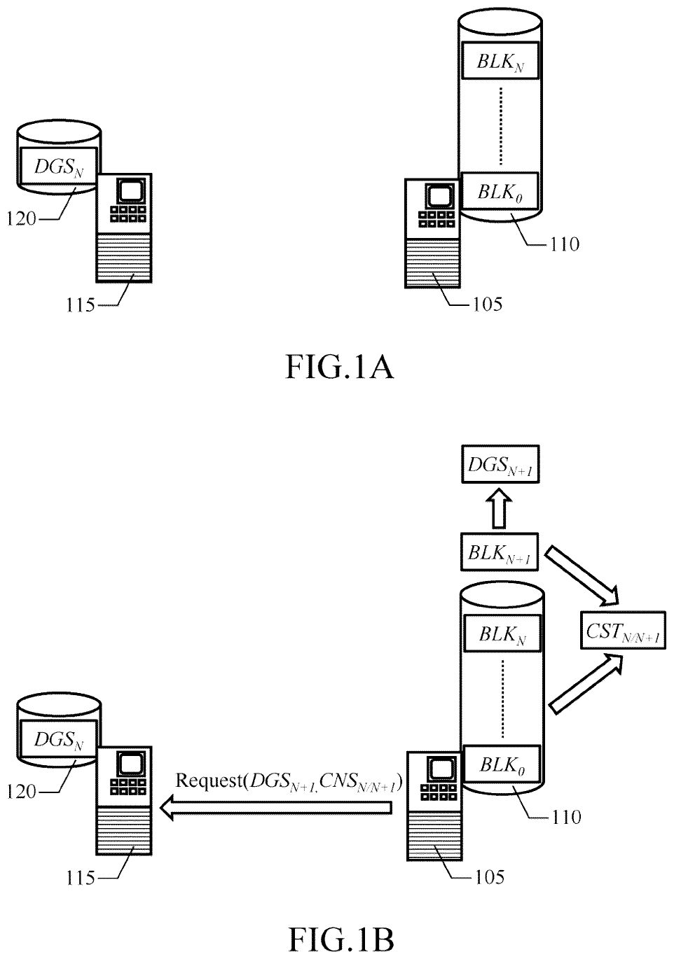

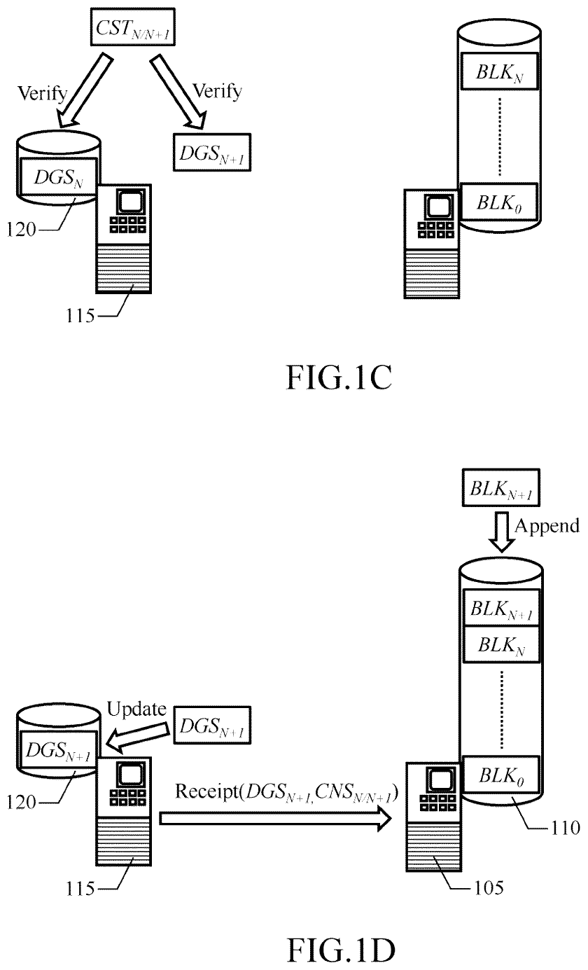

With reference now to FIG. 1A-FIG. 1D, the general principles are shown of the solution according to an embodiment of the present disclosure.

Starting from FIG. 1A, one or more storage computing systems, or simply storage nodes 105 (only one shown in the figure) store generic data (for example, logs, documents, transactions, chats and so on). The data are stored into one or more data structures, or simply ledgers 110 (only one shown in the figure). Each ledger 110 stores the corresponding data into (data) blocks BLKᵢ (with i=0 . . . N). The blocks BLKᵢ are arranged in a (chronological) succession defined by their appending to the ledger 110 (from block BLK₀ to block BLK_{N} in the example at issue). For this purpose, the blocks BLKᵢ may only be added in sequence by appending them to an end of the ledger 110. Therefore, the ledger 110 accumulates the data that are never removed from the ledger 110 once they have been added thereto (with any updates of the data that preserve all previous versions of the same data). A certification computing system, or simply certification server 115 controls the storing of the data in the corresponding ledgers

In the solution according to an embodiment of the present disclosure, for this purpose the certification server 115 stores corresponding (current) digests 120 of current versions of the ledgers 110, only one shown in the figure with value DGSN for the single ledger 110 at issue. In general, the digest of each ledger 110 is a value representative of the ledger 110 that is derived from its content (from the blocks BLK₀-BLK_{N} for the current digest DGS_{N}). For example, the digest is a hash value that is calculated by applying a cryptographic hash function to the content of the ledger 110. The cryptographic hash function is a hash function that maps data of arbitrary size to hash values of fixed-size. In addition, the cryptographic hash function is deterministic, i.e., it always produces the same hash value for the same input value (with a low risk of collision given by the same hash value for different input values and with an avalanche effect producing extensive changes of the hash value for small changes of the input data); the cryptographic hash function is also non-invertible, i.e., with the hash value that may be calculated from the input data in a relatively fast way but with the input data that is practically infeasible to be calculated from the hash value (because of a computational complexity involving a time complexity longer than a relevance period of the input data, for example, not of polynomial time).

Moving to FIG. 1B, the storage node 105 needs to add a (new) block BLK_{N+1} to the ledger 110 (to an end of its succession). For this purpose, the storage node 105 calculates the value of a (new) digest DGS_{N+1} of a new version of the ledger 110 that would be obtained by appending the new block BLK_{N+1} thereto (i.e., from the blocks BLK₀-BLK_{N+1}). Moreover, the storage node 105 determines a consistency proof CNS_{N/N+1} of the new version with respect to the current version of the ledger 110. In general, the consistency proof provides information that allows verifying that the new version and the current version of the ledger 110 are consistent (without the need of actually knowing them); this means that the new version contains the current version without any alteration and that the new version has been obtained by extending the current version (appending data to the end thereof). The storage node 105 then submits an appending request for the new block BLK_{N+1} to the certification server 115; the appending request comprises an indication of the new digest DGS_{N+1} (for example, its value) and the consistency proof CNS_{N/N+1}.

Moving to FIG. 1C, in response thereto the certification server 115 verifies the appending request. Particularly, this comprises verifying the consistency proof CNS_{N/N+1} (extracted from the appending request) according to the value DGS_{N} of the current digest 120 stored therein. For this purpose, the certification server 115 uses the consistency proof CNS_{N/N+1} to calculate the current digest and then it verifies whether matches its expected value DGS_{N}. Moreover, the the current digest so obtained certification server 115 obtains the new digest DGS_{N+1} satisfying the consistency proof CNS_{N/N+1}; for example, the certification server 115 uses the consistency proof CNS_{N/N+1} to calculate the new digest and then it verifies whether the new digest so obtained matches its expected value DGS_{N+1} extracted from the appending request.

Moving to FIG. 1D, if both verifications provide a positive result (meaning that the new version contains the current version without any alteration and that the new version has been obtained by appending the new block to the current version, respectively), the certification server 115 authorizes the corresponding writing of the ledger 110. For this purpose, the certification server 115 updates the current digest 120 of the ledger 110 to the value of the new digest DGS_{N+1}. At the same time, the certification server 115 returns an appending receipt to the storage node 105 in response to the appending request. The appending receipt is certified by the certification sever 115 (for example, by a corresponding digital signature); the appending receipt certifies the positive result of the verification of the appending request (meaning that the new version of the ledger 110 providing the value of the new digest DGS_{N+1} is consistent with the current version of the ledger 110 providing the value of the current digest DGS_{N}). The storage node 105 may now append the new block BLK_{N+1} to the ledger 110, which actually generates its new version; the new block BLK_{N+1} is appended to the ledger 110 in association with its appending receipt (certifying the consistency of the new version of the ledger 110).

The above-mentioned solution makes the persistency of each ledger 110 tamper-evident, since it allows verifying that the data of the ledger 110 have never been altered after their storing therein. For example, in this way it is possible to have multiple copies of the ledger 110 being mirrored onto corresponding storage nodes 105 that may write them independently, to audit the persistency of the ledger 110, to share the ledger 110 ensuring its consistency, to verify a correctness of operation of the certification server 115 and so.

The desired result is achieved without any need of exposing the data to the certification server 115. Particularly, the proposed solution only needs transmitting the appending requests (whose size is independent of the size of the data to be appended to the ledger 110) to the certification server 115. This substantially reduces any overloading of a network being used to communicate with the certification server 115, with a beneficial effect on performance. Moreover, the proposed solution avoids disseminating the data. This is important when access to the data has to be controlled by restricting it selectively (especially when the data are subject to strict confidentiality requirements).

The proposed solution is quite simple, thereby involving a relatively low consumption of networking, computational and storage resources (especially with respect to the use of a blockchain for storing the data).

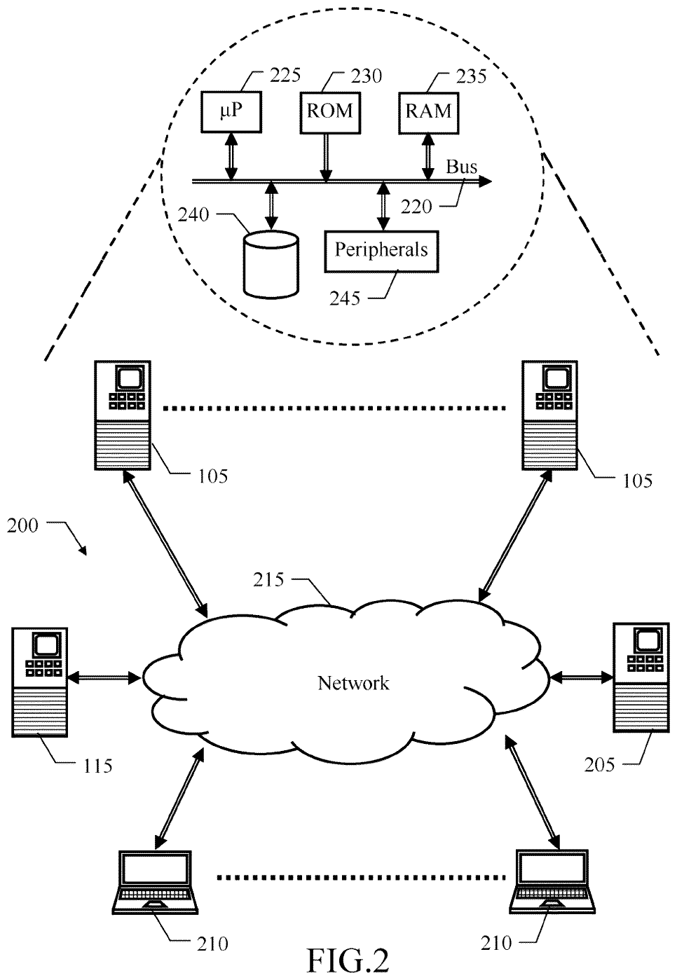

With reference now to FIG. 2, a schematic block diagram is shown of a computing infrastructure 200 that may be used to implement the solution according to an embodiment of the present disclosure.

The (computing) infrastructure 200 comprises the above-mentioned storage nodes 105 and certification server 115. The certification server 115 is trusted to its operation of certifying the appending receipts. In general terms, this means that the certification server 115 is relied upon to the verification of the consistency proofs of the appending requests, so that the appending receipts being certified by the certification server 115 ensures that the corresponding blocks have been appended to each ledger preserving its previous version (and then that the ledger is persistent). The correctness of the verification of the consistency proofs of the appending requests by the certification server 115 (known trust) is provided independently of the appending receipts (expected information), for example, as a result of a collaborative verification of operation of the certification server 115 by the storage nodes 105 (as described in the following).

Moreover, the infrastructure 200 comprises a Public Key Infrastructure (PKI) server computing system, or simply PKI server 205 (or more) of a Certification Authority (CA) that implements a PKI service. The PKI service leverages an asymmetric encryption technique involving the use of pairs of keys, each formed by a (non-confidential) public key and a (confidential) private key that are generated so that it is computationally unfeasible to obtain the private key from the public key. Each of the keys (either the public one or the private one) is used to encrypt information in original form (plaintext) into an unintelligible form (cyphertext); the other key is used to decrypt the (encrypted) information to restore its original form. The certification authority guarantees an identity of subjects associated with the pairs of public/private keys (the storage nodes 105 and the certification server 115 in the application at issue) by means of digital certificates thereof. Each digital certificate contains identification information of the subject, its public key, and a name of the certification authority. The digital certificate is digitally signed by the certification authority with its private key (with the identity of the certification authority that is guaranteed by an upper-level certification authority, up to a main certification authority being generally trusted). The infrastructure 200 further comprises a plurality of client computing systems, or simply clients 210. The clients 210 are used to access the data stored in the storage nodes 105 by (authorized) users thereof and/or to verify the consistency of the data stored in the storage nodes 105 by (entrusted) auditors. The storage nodes 105, the certification server 115, the PKI server 205 and the clients 210 communicate among them over a (telecommunication) network 215, for example, of global type based on the Internet.

Each of the above-described computing systems (storage nodes 105, certification server 115, PKI server 205 and clients 210) comprises several units that are connected among them through a bus structure 220 at one or more levels (with an architecture that is suitably scaled according to the type of the computing system 105,115,205,210). Particularly, a microprocessor (μP) 225, or more, provides a logic capability of the computing system 105,115,205,210; a non-volatile memory (ROM) 230 stores basic code for a bootstrap of the computing system 105,115,205,210 and a volatile memory (RAM) 235 is used as a working memory by the microprocessor 225. The computing system 105,115,205,210 is provided with a mass-memory 240 for storing programs and data (for example, storage devices of a data center wherein each node/server 105,115,205 is implemented and a Solid-State Disk, or SSD, for each client 210). Moreover, the computing system 105,115,205,210 comprises a number of controllers for peripherals, or Input/Output (I/O) units, 245; for example, the peripherals 245 of each node/server 105,115,205 comprise a network adapter for plugging the node/server 105,115,205 into the corresponding data center and then connecting it to a console of the data center for its control (for example, a personal computer, also provided with a drive for reading/writing removable storage units, such as of USB type) and to a switch/router sub-system of the data center for its communication with the network 215, whereas the peripherals 245 of each client 210 comprise a keyboard, a mouse, a monitor, a network adapter for connecting to the network 215 and a drive for reading/writing removable storage units (such as of USB type).

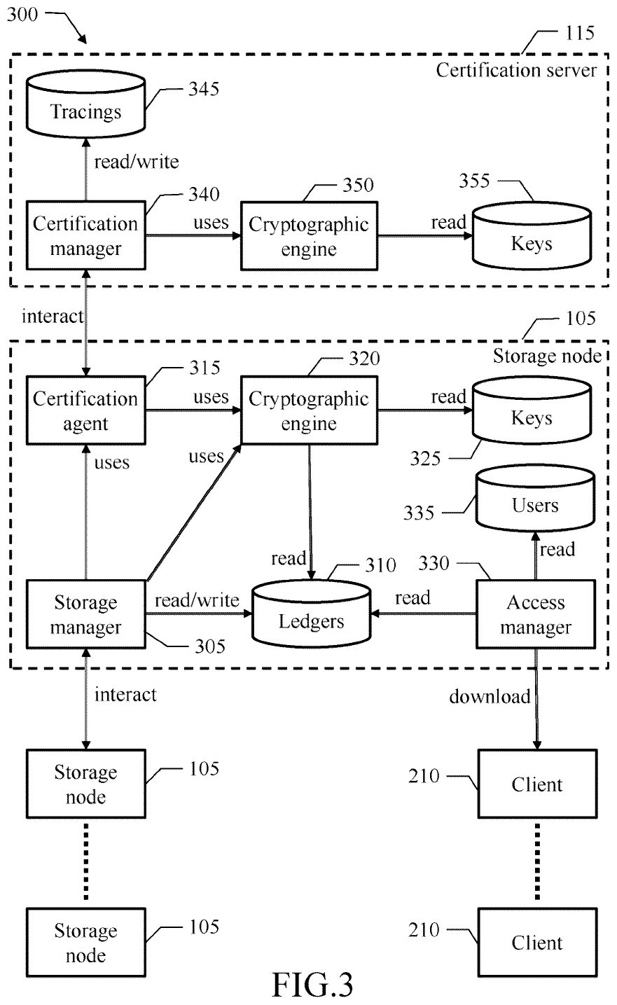

With reference now to FIG. 3, the main software components are shown that may be used to implement the solution according to an embodiment of the present disclosure.

Particularly, all the software components (programs and data) are denoted as a whole with the reference 300. The software components are typically stored in the mass memory and loaded (at least partially) into the working memory of each computing system when the programs are running, together with an operating system and other application programs not directly relevant to the solution of the present disclosure (thus omitted in the figure for the sake of simplicity). The programs are initially installed into the mass memory, for example, from removable storage units or from the network. In this respect, each program may be a module, segment or portion of code, which comprises one or more executable instructions for implementing the specified logical function.

Starting from each storage node 105 (only one shown in the figure) it comprises the following components. A storage manager 305 manages the storing of data. The storage manager 305 reads/writes a ledger repository 310 that contains information relating to (local) ledgers being managed by the storage node 105 and to (remote) ledgers, or at least part thereof, being not managed by the storage node 105. For example, the ledger repository 310 has an entry for each (local/remote) ledger. In case of a local ledger, the entry stores a header comprising a (unique) identifier of the (local) ledger, an author list of one or more author (storage) nodes 105 being authorized to write the ledger, and a peer list of possible other peer (storage) nodes 105 on which the ledger is mirrored (identified according to their digital certificates). The author list also indicates the author nodes 105 that are authorized to update the author/peer lists (with each update performed by an author node 105 that is distributed to the other peer nodes 105 and to the certification server 115 via a corresponding update request being digitally signed by the author node 105, so as to cause each of them to verify the update request (by verifying its digital signature and that the author node 105 is authorized to update the author/peer list according to the current version of the author list) and to update the author/peer list accordingly in response to a positive verification of the update request). The entry further stores the ledger comprising a record list formed by a (chronological) succession of one or more records. Each record contains a (data) block and a corresponding creation/appending receipt, which in turn contains a current version of the digest of the ledger (current digest) up to this block. Particularly, a first record contains a null block and a creation receipt being provided by the certification server 115 that certifies the creation of the ledger (as described in the following); each following record instead contains a block being appended to the ledger and an appending receipt being provided by the certification server 115 that certifies the appending of the block (as described in the following). Instead, in case of a remote ledger the entry only stores the identifier of the ledger and a receipt list formed by a (chronological) succession of its creation/appending receipts.

The storage manager 305 interacts with the other storage nodes 105. The storage manager 305 uses a certification agent 315. The certification agent 315 interacts with the certification server 115 for obtaining the creation/appending receipts. A cryptographic engine 320 is used by the certification agent 315 and by the storage manager 305. The cryptographic engine 320 performs cryptographic operations based on the PKI service (interacting with the PKI server, not shown in the figure). The cryptographic engine 320 reads the ledger repository 310 and a key repository 325. The key repository 325 stores (in a protected way) the private key of the storage node 105 and its digital certificate being issued by the PKI server. An access manager 330 manages access to the data stored in the storage node 105. The access manager 330 reads the ledger repository 310 and a user repository 335. The user repository 335 indicates the (authorized) users (such as identified by corresponding pairs of userID/password) that are authorized to read the ledgers stored in the storage node 105, either indiscriminately or selectively (such as per types of ledgers, roles of users and so on). The access manager 330 downloads data extracted from the ledgers to the clients 210.

Moving to the certification server 115, it comprises the following components. A certification manager 340 manages the certifications of operations performed on the ledgers stored in all the storage nodes 105 (i.e., creation of new ledgers and appending of new blocks). The certification manager 340 interacts with the certification agents 315 of all the storage nodes 105. The certification manager 340 reads/writes a tracing repository 345. The tracing repository 345 contains tracing information relating to the ledgers being used to certify the creation/appending operations performed thereon. For example, the tracing repository 345 has an entry for each ledger. The entry stores the identifier of the ledger, the author list and the current digest of the ledger being certified by the certification server 115. The certification manager 340 uses a cryptographic engine 350. In this case as well, the cryptographic engine 350 performs cryptographic operations based on the PKI service (interacting with the PKI server). The cryptographic engine 350 reads a key repository 355. The key repository 355 stores (in a protected way) the private key of the certification server 115 and its digital certificate being issued by the PKI server.

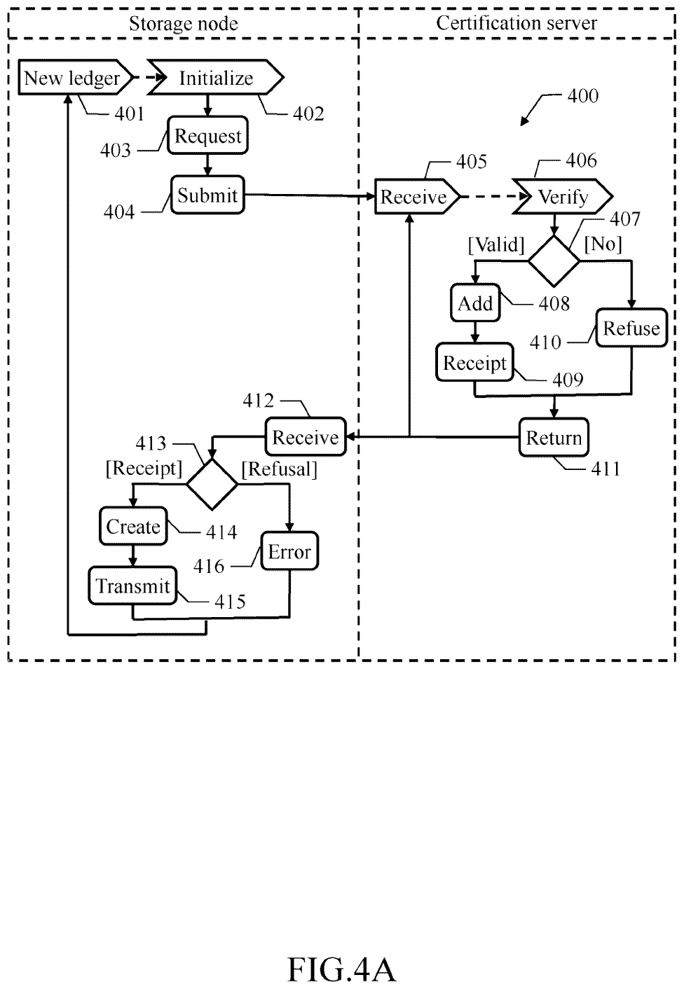

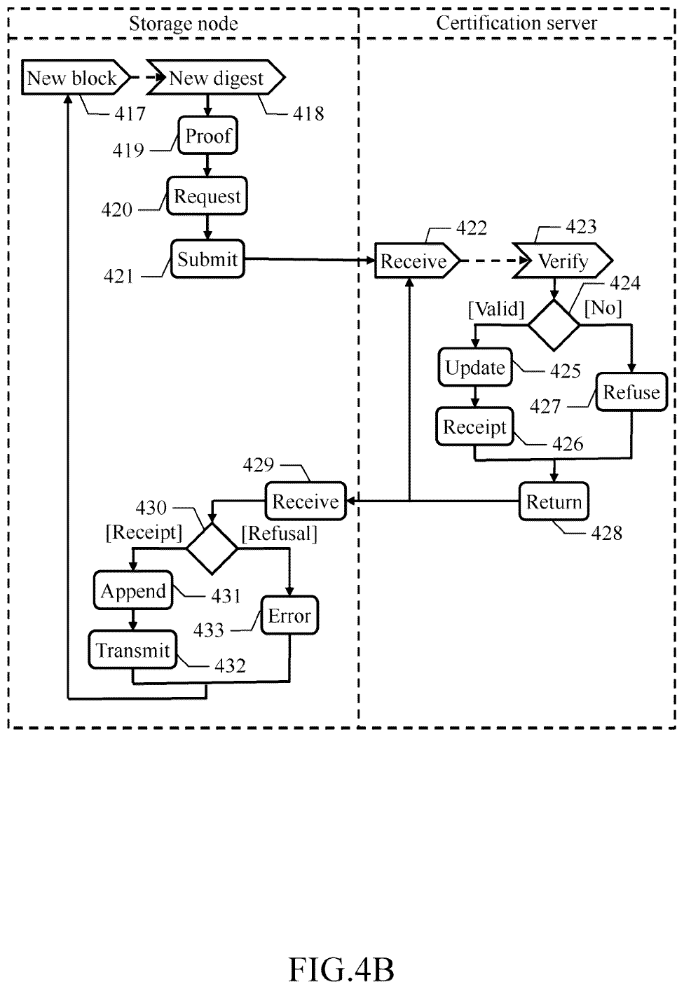

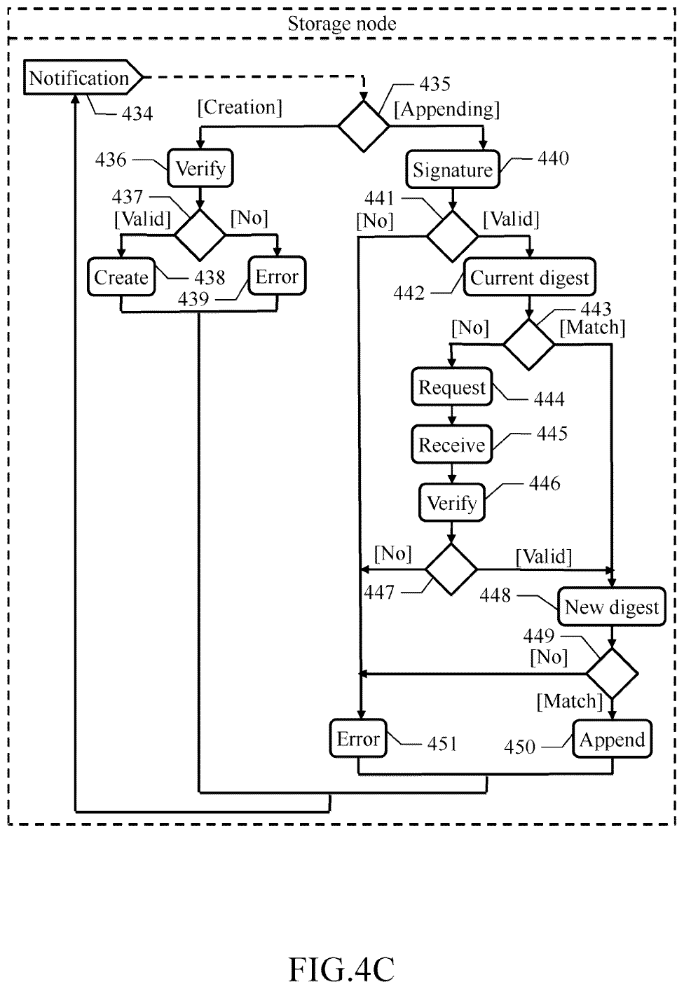

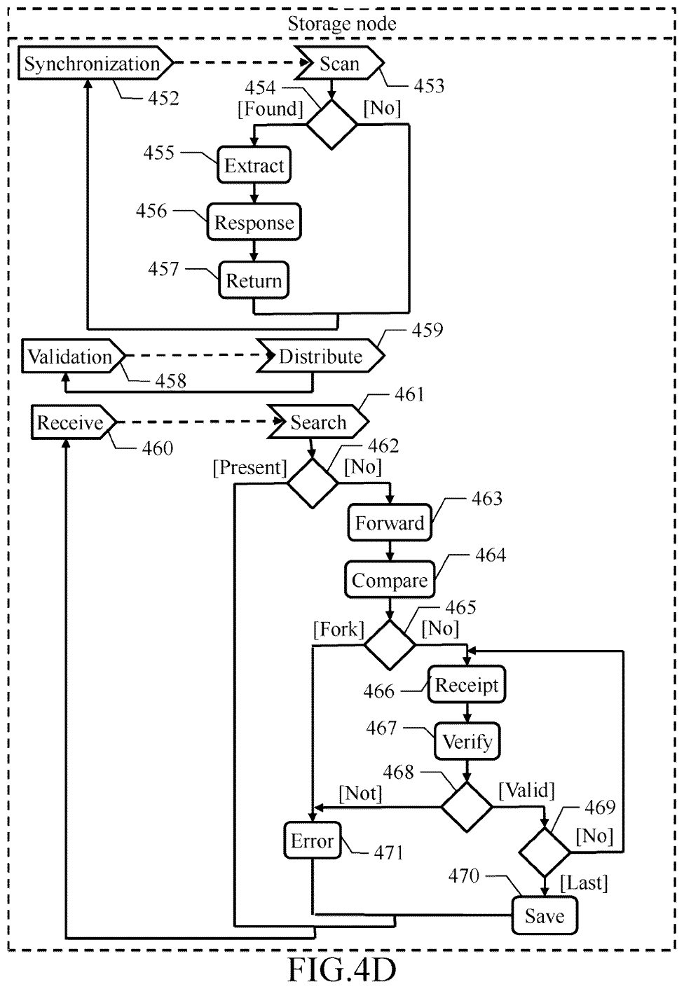

With reference now to FIG. 4A-FIG. 4D, an activity diagram is shown describing the flow of activities relating to an implementation of the solution according to an embodiment of the present disclosure.

Particularly, the diagram represents an exemplary process that may be used to store tamper-evident data with a process 400. In this respect, each block may correspond to one or more executable instructions for implementing the specified logical function on the relevant computing system.

The process passes from block 401 to block 402 in the swim-lane of a generic storage node as soon as a (new) ledger has to be created. For example, this happens when a (creation) command is received from a software application running on the storage node, is entered manually by an administrator of the storage node, is submitted by the client of an authorized user and so on. In response thereto, the storage manager initializes the identifier, the author list, the peer list and an initial value of the digest of the new ledger (initial digest). The identifier of the new ledger may be set to an identifier of the storage node (such as its host name) with the appending of a progressive number, to a code derived from a current time and so on. The author list and the peer list are set as indicated in the creation command (either explicitly or implicitly, such as via corresponding roles, rules as so on). The initial digest is set to a pre-defined value (for example, 0). The certification agent at block 403 generates a creation request for creating the new ledger. For this purpose, the certification agent builds a (creation) body containing the identifier of the new ledger, the author list, the peer list and the initial digest. Moreover, the certification agent generates (via the cryptographic engine) a digital signature of the body, by calculating its hash value and then encrypting it with the private key of the storage node (retrieved from the corresponding repository). The certification agent then generates the creation request by inserting the body, its digital signature and the digital certificate of the storage node (retrieved from the corresponding repository via the cryptographic engine). The certification agent at block 404 submits the creation request to the certification server.

Moving to the swim-lane of the certification server, the process passes from block 405 to block 406 as soon as the certification manager (being in a listening condition for it) receives any creation request (from the storage node at block 404 in the example at issue). In response thereto, the certification manager verifies the creation request. Particularly, the certification manager verifies that the identifier of the new ledger (extracted from the creation request) is not already used by other ledgers, i.e., it is not present in the tracing repository. The certification manager also verifies (via the cryptographic engine) that the digital signature in the creation request is valid. For this purpose, the certification manager verifies that the digital certificate (extracted from the creation request) is still active, i.e., it has not been revoked (for example, as indicated in a certificate revocation list published by the PKI server, not shown in the figure). Moreover, the certification manager decrypts the digital signature with the public key of the storage node (extracted from its digital certificate), calculates the hash value of the body and verifies that the decrypted/calculated values match. The flow of activity branches at block 407 according to a result of this verification. If all the above-mentioned conditions are met, the certification manager at block 408 accepts the (valid) creation request. Particularly, the certification manager adds a new entry to the tracing repository with the identifier, the author list and the current digest set to the initial digest of the new ledger (extracted from the creation request). The certification manager at block 409 generates a corresponding creation response to the creation request. The creation response is set to a creation receipt (or authorization) for the new ledger. For this purpose, the certification manager generates (via the cryptographic engine) a digital signature of the creation request, by calculating its hash value and then encrypting it with the private key of the certification server (retrieved from the corresponding repository). The certification manager then generates the creation receipt by inserting the creation request, its digital signature and the digital certificate of the certification server (retrieved from the corresponding repository via the cryptographic engine). The process instead continues to block 410 from block 407 if the identifier of the new ledger is already used and/or if the digital signature in the creation request is not valid (i.e., digital certificate of the storage node revoked and/or decrypted/calculated values not matching). In this case, the certification manager refuses the (non-valid) creation request. For this purpose, the certification manager generates the creation response by setting it to a refusal notice (for example, containing an indication of the reason of the refusal of the creation request). The flow of activity merges again at block 411 from block 409 or from block 410. The certification manager now returns the creation response to the storage node. The process then goes back to block 405 waiting for a next creation request.

Referring again to the swim-lane of the storage node, the certification agent at block 412 receives the creation response from the certification server (being in a listening condition for it from block 404). The flow of activity branches at block 413 according to the creation response. If the creation response is the creation receipt (creation request accepted), the storage manager at block 414 creates the new ledger. For this purpose, the storage manager adds a new entry to the ledger repository. The new entry contains a header with the identifier of the ledger, the author list and the peer list. The new entry also contains the new ledger with an (initial) record containing a null block and the creation receipt, in turn containing the initial digest. Moreover, in case the ledger is mirrored on other peer nodes (peer list not empty), the storage manager at block 415 transmits a mirroring notification to each peer node; the mirroring notification contains the initial record, in turn containing the identifier of the ledger, the author list, the peer list and the initial digest. The process instead continues to block 416 from block 413 if the creation response is the refusal notice (creation request refused). In this case, the storage manager returns an error message to the creation command (for example, containing the indication of the reason of the refusal of the creation command extracted from the refusal notice). The process then returns from block 415 or from block 416 to block 401 waiting for a next creation command.

In a completely independent way, the process passes from block 417 to block 418 as soon as a (new) block has to be added to a (local) ledger stored in the storage node (being an author node thereof). For example, this happens when an (appending) command is received from a software application running on the storage node, is entered manually by the administrator of the storage node, is submitted by a client of an authorized user and so on. In response thereto, the storage manager calculates (via the cryptographic engine) a new value of the digest (new digest) of the new version of the ledger that would be obtained by appending the new block to its current version. For example, in general the digest of the ledger is calculated as the Merkle tree hash of its blocks. For this purpose, the hash values of the blocks are arranged into a Merkle tree, which is a binary tree having its leaf nodes labelled with the hash values of the blocks, in the same order of their succession in the ledger. Each inner node of the Merkle tree is labelled with the hash value of the concatenation of the hash values of its (two) child nodes, up to the hash value of a root node of the Merkle tree that defines the digest of the ledger. For example, in case of a very simple ledger with 7 blocks BLK₀-BLK₆ having corresponding hash values H₀-H₆, a hash value H₀₁ is calculated by pairing the hash values H₀ and H₁, a hash value H₂₃ is calculated by pairing the hash values H₂ and H₃, a hash value H₄₅ is calculated by pairing the hash values H₄ and H₅, a hash value H₀₃ is calculated by pairing the hash values H₀₁ and H₂₃, a hash value H₄₆ is calculated by pairing the hash values H₄₅ and H₆, and a hash value H₀₆ is calculated by pairing the hash values H₀₃ and H₄₆ (which hash value H₀₆ defines the digest of the ledger). The storage manager at block 419 determines (via the cryptographic engine) the consistency proof of the new version with respect to the current version of the ledger. For example, in this case the consistency proof is the Merkle consistency proof. The Merkle consistency proof is defined by the minimum set of hash values in the Merkle tree of the new version of the ledger that are required to verify that the new version contains the current version of the ledger without any alteration and that the new version has been obtained by extending the current version (appending the new block to the end thereof). In the above-mentioned example, a very simple consistency proof for the appending of a (single) new block BLK₇ having corresponding hash value H₇ is defined by a list of hash values H₀₃,H₄₅,H₆ for verifying the containment of the current version plus the hash value H₇ for verifying the appending of the new block. Particularly, by accumulating the corresponding list of hash values from right to left into a single hash value, i.e., calculating the hash value H₄₆ by pairing the hash values H₄₅ and H₆, and calculating the hash value H₀₆ by pairing the hash values H₀₃ and H₄₆, and then comparing the hash value H₀₆ with the current digest it is possible to verify whether the new version contains the (unaltered) current version of the ledger. Likewise, by accumulating the corresponding list of hash values from right to left into a single hash value, i.e., calculating a hash value H₆₇ by pairing the hash values H₆ and H₇, calculating a hash value H₄₇ by pairing the hash values H₄₅ and H₆₇, and calculating a hash value H₀₇ by pairing the hash values H₀₃ and H₄₇, and then comparing the hash value Ho with the new digest it is possible to verify whether the new version has been obtained by extending the current version. The certification agent at block 420 generates an appending request for appending the new block to the ledger. For this purpose, the certification agent builds an (appending) body containing the identifier of the ledger, the new digest and the consistency proof. Moreover, the certification agent generates (via the cryptographic engine) a digital signature of the body, by calculating its hash value and then encrypting it with the private key of the storage node (retrieved from the corresponding repository). The certification agent then generates the appending request by inserting the body, its digital signature and the digital certificate of the storage node (retrieved from the corresponding repository via the cryptographic engine). The certification agent at block 421 submits the appending request to the certification server.

Moving to the swim-lane of the certification server, the process passes from block 422 to block 423 as soon as the certification manager (being in a listening condition for it) receives any appending request (from the storage node at block 421 in the example at issue). In response thereto, the certification manager verifies the appending request. Particularly, the certification manager verifies that the identifier of the ledger (extracted from the appending request) exists, i.e., it is present in the tracing repository. The certification manager also verifies (via the cryptographic engine) that the digital signature in the appending request is valid as above (i.e., digital certificate active and decrypted/calculated values matching). The certification manager also verifies that the storage node is authorized to write the ledger (i.e., it is comprised in the author list of the ledger in the tracing repository). The certification manager also verifies that the consistency proof is satisfied. For this purpose, the certification manager uses the consistency proof to calculate the current digest of the ledger and verifies that it matches the one stored in the corresponding entry of the tracing repository; moreover, the certification manager uses the consistency proof to calculate the new digest of the ledger and verifies that it matches the one indicated in the appending request. The flow of activity branches at block 424 according to a result of this verification. If all the above-mentioned conditions are met, the certification manager at block 425 accepts the (valid) appending request. Therefore, the certification manager replaces the current digest of the ledger in the tracing repository with the new digest. The certification manager at block 426 generates a corresponding appending response (or authorization) for the appending request. The appending response is set to an appending receipt for the new block. For this purpose, the certification manager generates (via the cryptographic engine) a digital signature of the appending request, by calculating its hash value and then encrypting it with the private key of the certification server (retrieved from the corresponding repository). The certification manager then generates the appending receipt by inserting the appending request, its digital signature and the digital certificate of the certification server (retrieved from the corresponding repository via the cryptographic engine). The process instead continues to block 427 from block 424 if the identifier of the ledger does not exit, the digital signature in the appending request is not valid, the storage node is not comprised in the author list of the ledger and/or the consistency proof is not satisfied. In this case, the certification manager refuses the (non-valid) appending request. For this purpose, the certification manager generates the appending response by setting it to a refusal notice (for example, containing an indication of the reason of the refusal of the appending request). Particularly, this may happen in case of concurrent appending requests of a same ledger by different author nodes thereof starting from the same current version of the ledger; in this case, the first appending request that is received by the certification server is accepted, whereas the other appending requests are refused since the current digest of the ledger has been changed meanwhile and then the consistency proof is not satisfied any longer (with each refused appending request that is to be re-submitted starting from the new digest of the ledger). The flow of activity merges again at block 428 from block 426 or from block 427. The certification manager now returns the appending response to the storage node. The process then goes back to block 422 waiting for a next appending request.

Referring again to the swim-lane of the storage node, the certification agent at block 429 receives the appending response from the certification server (being in a listening condition for it from block 421). The flow of activity branches at block 430 according to the appending response. If the appending response is the appending receipt (appending request accepted), the storage manager at block 431 appends the new block to the ledger. For this purpose, the storage manager adds a new record to the ledger (in the corresponding repository). The new record contains the new block and the appending receipt, in turn containing the new digest. Moreover, in case the ledger is mirrored on other peer nodes (as indicated in the corresponding repository), the storage manager at block 432 transmits a mirroring notification to each peer node; the mirroring notification contains the new record, in turn containing the identifier of the ledger, the new digest and the consistency proof. The process instead continues to block 433 from block 430 if the appending response is the refusal notice (appending request refused). In this case, the storage manager returns an error message to the appending command (for example, containing the indication of the reason of the refusal of the appending command extracted from the refusal notice). The process then returns from block 432 or from block 433 to block 417 waiting for a next appending command.

The above-described procedure makes the creation/appending operations performed on the ledger non-repudiable; particularly, the digital signatures in the creation/appending requests make the corresponding creation/appending operations non-repudiable by the storage nodes and the digital signatures in the creation/appending receipts make the verifications (and authorizations) of the corresponding creation/appending operations non-repudiable by the certification server.

In a completely independent way, the process passes from block 434 to block 435 as soon as the storage manager (being in a listening condition for it) receives a (further) mirroring notification from any peer node. The flow of activity then branches according to a type of the mirroring notification. If the storage manager has received a mirroring notification of an initial record of a new (mirrored) ledger, the storage manager at block 436 verifies its creation receipt. Particularly, the storage manager verifies (via the cryptographic engine) that the digital signature in the creation receipt and that the digital signature in the creation request are valid as above (i.e., digital certificate of the certification server and of the peer node, respectively, active and decrypted/calculated values matching). The flow of activity branches at block 437 according to a result of this verification. If both the digital signatures are valid, the storage manager at block 438 accepts the (valid) creation receipt. Therefore, the storage manager creates a mirrored copy of the new ledger as above, by adding a new entry to the ledger repository containing a header (with the identifier of the ledger, the author list and the peer list) and a new ledger (with the initial record) as extracted from the creation request. The process instead continues to block 439 from block 437 if any digital signature is not valid. In this case, the storage manager enters an error condition, for example, by outputting an error message containing the indication of the reason of the refusal of the (non-valid) mirroring notification.

Referring back to block 435, if the storage manager has received a mirroring notification of a new record of a (mirrored) ledger, the storage manager at block 440 verifies that the digital signature in its appending receipt and that the digital signature in its appending request are valid as above (i.e., digital certificate of the certification server and of the peer node, respectively, active and decrypted/calculated values matching). The storage manager also verifies that the peer node is authorized to write the ledger (i.e., it is comprised in the author list of the ledger in the corresponding repository, if any). The flow of activity branches at block 441 according to a result of this verification. If all the above-mentioned conditions are met, the storage manager at block 442 verifies that the consistency proof of the appending request is satisfied. For this purpose, at first the storage manager uses the consistency proof to calculate the current digest of the ledger and verifies that it matches the one stored in the corresponding repository, if any. The flow of activity branches at block 443 according to a result of this verification. If the two values of the current digest differ, it is possible that the (mismatched) ledger has lost its synchronization with the other (most recent) copies thereof because the storage node has not received one or more mirroring notifications containing corresponding new records (for example, in case of temporary unavailability of the storage node, network error and so on). In this case, the storage manager at block 444 submits a synchronization request to the peer nodes of the ledger (as indicated in the ledger repository). The same synchronization request is also submitted to the (only known) peer node from which the mirroring notification has been received when the ledger is new since not present in the storage node (meaning that it has been just added to the corresponding peer list). The synchronization request comprises the identifier of the ledger, a start digest equal to the current digest of the ledger stored in the corresponding repository (or a null value otherwise) and an end digest equal to the current digest of the ledger determined by the consistency proof of the appending request. The process continues to block 445 as soon as the storage manager receives a corresponding synchronization response from anyone of the peer nodes. As described in the following, the synchronization response comprises a list of one or more (missing) records of (missing) blocks that have been appended to the ledger (after the last one available in the storage node or all of them otherwise) arranged in (chronological) succession (with the addition of the author list and the peer list in case the ledger is new). The storage manager at block 446 verifies the synchronization response. Particularly, if the ledger is new the storage manager at first verifies its initial record, by verifying that the digital signature in the creation receipt and that the digital signature in the creation request are valid as above. In any case, the storage manager verifies the missing records (different from the possible initial record) along their succession. Particularly, for each missing record the storage manager verifies that the digital signature in the appending receipt is valid, that the digital signature in the appending request is valid and that the consistency proof is satisfied; for a first missing record the consistency proof is verified with respect to the current digest equal to the one stored in the storing node if any or to the initial digest comprised in the creation receipt otherwise, and for any next missing record the consistency proof is verified with respect to the current digest equal to the new digest indicated in the appending request of a previous missing record. The flow of activity branches at block 447 according to a result of this verification. If all the above-mentioned conditions are met for all the missing records of the synchronization response, the process continues to block 448; the same point is also reached from block 443 if the values of the current digest calculated from the consistency proof of the mirroring notification and stored in the ledger repository are the same. In both cases, the storage manager continues the verification of the consistency proof of the mirroring notification by using it to calculate the new digest of the ledger and verifying that it matches the one of the new version of the ledger that would be obtained by appending the possible missing blocks and the new block. The flow of activity branches at block 449 according to a result of this verification. If the two values of the new digest are the same, the storage manager at block 450 accepts the corresponding (valid) missing/new record(s). Therefore, if the ledger is new the storage manager creates it as above; in any case, for each missing/new record (along the possible succession of the synchronization response) the storage manager adds the missing/new record to the ledger (so as to append the corresponding missing/new block thereto). The process instead continues to block 451 from block 441 if any digital signature in the mirroring notification is not valid and/or the peer node is not authorized to write the ledger, from block 447 if any missing record is not valid (i.e., any digital signature not valid, consistency proof not satisfied) and/or from block 449 if the two values of the new digest differ. In this case, the storage manager enters an error condition (for example, by outputting an error message containing the indication of the reason of the refusal of the mirroring notification).

The process then returns from block 438, from block 439, from block 450 or from block 451 to block 434 waiting for a next mirroring notification.

In a completely independent way, the process passes from block 452 to block 453 as soon as the storage manager (being in a listening condition for it) receives a synchronization request from any peer node. In response thereto, the storage manager verifies the synchronization request. Particularly, the storage manager verifies that the peer node is comprised in the peer list of the ledger indicated by the identifier extracted from the synchronization request. The storage manager also scans the ledger backwards (in the corresponding repository), looking for a record containing the end digest and then for a (preceding) record containing the start digest indicated in the synchronization request (if different from the null value). The flow of activity branches at block 454 according to a result of this verification. If all the above-mentioned conditions are met, the storage manager at block 455 extracts the records after the one containing the start digest (or from the beginning of the ledger if equal to the null value) up to the one containing the end digest from the ledger. The storage manager at block 456 generates a synchronization response for the synchronization request by inserting the records being extracted in their succession (with the addition of the author list and the peer list in case the start digest is equal to the null value). The storage manager at block 457 returns the synchronization response to the corresponding peer node. In this way, the synchronization response only contains the records that are actually required by the peer node (without possible further records that may have been appended to the ledger after the one to which the new block of the mirroring notification has to be appended by the peer node). The process returns from block 457 or directly from block 454 (if the peer node is not comprised in the peer list of the ledger and/or the above-mentioned search has not been successful) to block 452 waiting for a next synchronization request. In this way, no synchronization response is returned when the ledger is not up-to-date.

The above-described procedure ensures that all the mirrored copies of the ledger are consistent. Moreover, the digital signatures in the creation/appending requests by the storage nodes allow attributing corresponding authorship to every creation/appending operations performed on the ledger.

In a completely independent way, the process passes from block 458 to block 459 as soon as an event triggering a validation of the certification server occurs. For example, this may happen periodically, upon request, for every creation/appending operation and so on. In response thereto, information required to validate the certification server is disseminated throughout all the other remote (storage) nodes with a gossip protocol. For this purpose, the storage manager selects a pre-defined number of the remote nodes (such as 2-5) in a random way (such as from a public directory). The storage manager distributes corresponding validation messages for its ledgers (or a part thereof) to the selected remote nodes. Each validation message contains an identifier of the storage node (such as its host name), the identifier of the corresponding ledger and a receipt list formed by the (chronological) succession of the creation/appending receipts of the ledger (extracted from the corresponding repository). The process then returns to block 458 waiting for a next validation event.

The process instead passes from block 460 to block 461 as soon as the storage manager of the (current) storage node (being in a listening condition for it) receives a (further) validation message from a remote node. In response thereto, the storage manager searches the ledger repository for an entry relating to the (remote) ledger of the validation message and verifies whether it contains the same receipt list of the validation message. The flow of activity branches at block 462 according to a result of this search. If the result is negative, this means that the validation message has been received for the first time by the current storage node. Therefore, as above the storage manager at block 463 selects the same pre-defined number of the remote nodes (randomly) and forwards the validation message thereto. At the same time, the storage manager at block 464 compares the receipt list of the validation message with the receipt list of the ledger in the corresponding repository (if any). The flow of activity branches at block 465 according to a result of this search. If the receipt list of the validation message extends the receipt list of the ledger repository (always true when no entry for the ledger exists in the corresponding repository), a loop is entered at block 466 wherein the storage manager takes a (present) creation/appending receipt of the validation message not present in the ledger repository into account (starting from the first one possibly down to the creation receipt). The storage manager at block 467 verifies the creation/appending receipt. Particularly, the storage manager verifies that the digital signature in the creation/appending receipt and the digital signature in the creation/appending request are valid and (apart from the creation receipt) that the consistency proof of the appending receipt is satisfied with respect to its previous creation/appending receipt. The flow of activity branches at block 468 according to a result of this verification. If all the above-mentioned conditions are met, the storage manager at block 469 verifies whether a last creation/appending receipt of the validation message has been processed. If not, the flow of activity returns to block 466 to repeat the same operations on a next creation/appending receipt of the validation message. Conversely, once all the creation/appending receipts of the validation messages have been successfully verified, this means that operation of the certification server is correct. Therefore, the storage manager at block 470 saves the receipt list of the verification message into the corresponding repository (by extending its possible previous version). The process instead continues to block 471 from block 465 if the receipt list of the validation message does not extend the receipt list of the ledger repository (meaning that a fork of the ledger occurred) or from block 468 if the creation/appending receipt of the validation message is not valid (i.e., digital signatures not valid and/or consistency proof not satisfied). In this case, the storage manager enters an error condition. For example, a corresponding error message is provided to the administrator of the storage node warning that operation of the certification server is not correct. The error message indicates a nature of the error (fork, invalid signature, unsatisfied consistency proof). Moreover, the error message contains the corresponding creation/appending receipts; this provides a self-contained and non-repudiable proof of the error that may be verified by everybody (even without a copy of the ledger). The process then returns from block 470, from block 471 or directly from block 462 (if the same validation message has already been received) to block 460 waiting for a next validation message.

The above-described procedure allows verifying operation of the certification server in a collaborative way by the storage nodes, so as to make it generally trusted in a relatively simple way.

The same operations described above may also be performed to audit/share any ledger (either completely or limited to an initial portion thereof). Briefly (not shown in the figure), whenever the persistency of a ledger has to be audited, a succession of the creation/appending receipts of the ledger is provided by a corresponding storage node to the (auditor) client of an auditor in response to a corresponding auditing request. The auditor client verifies the creation/appending receipts in succession as above (particularly, verifying that the digital signature in each creation/appending receipt and in its creation/appending request are valid and verifying that the consistency proof of each appending receipt is satisfied). If all the above-mentioned conditions are met, the auditor client may certify that the ledger (in its version corresponding to the new digest of a last appending receipt) is consist. This result is achieved with any need of exposing the data to the auditor. Likewise, whenever the ledger has to be shared, a succession of the records of the ledger is provided by a corresponding storage node to the (user) client of an (authorized) user in response to a corresponding sharing request. The user client verifies the records in succession as above (particularly, verifying that the digital signature in the creation/appending receipt of each record and in its creation/appending request are valid and verifying that the consistency proof of each appending receipt is satisfied). If all the above-mentioned conditions are met, the user client may accept the ledger as defined by the blocks in the sharing response (being guaranteed that the ledger is consistent).

### Modifications

Naturally, in order to satisfy local and specific requirements, a person skilled in the art may apply many logical and/or physical modifications and alterations to the present disclosure. More specifically, although this disclosure has been described with a certain degree of particularity with reference to one or more embodiments thereof, it should be understood that various omissions, substitutions and changes in the form and details as well as other embodiments are possible. Particularly, different embodiments of the present disclosure may be practiced even without the specific details (such as the numerical values) set forth in the preceding description to provide a more thorough understanding thereof; conversely, well-known features may have been omitted or simplified in order not to obscure the description with unnecessary particulars. Moreover, it is expressly intended that specific elements and/or method steps described in connection with any embodiment of the present disclosure may be incorporated in any other embodiment as a matter of general design choice. Moreover, items presented in a same group and different embodiments, examples or alternatives are not to be construed as de facto equivalent to each other (but they are separate and autonomous entities). In any case, each numerical value should be read as modified according to applicable tolerances; particularly, unless otherwise indicated, the terms “substantially”, “about”, “approximately” and the like should be understood as within 10%, preferably 5% and still more preferably 1%. Moreover, each range of numerical values should be intended as expressly specifying any possible number along the continuum within the range (comprising its end points). Ordinal or other qualifiers are merely used as labels to distinguish elements with the same name but do not by themselves connote any priority, precedence or order. The terms include, comprise, have, contain, involve and the like should be intended with an open, non-exhaustive meaning (i.e., not limited to the recited items), the terms based on, dependent on, according to, function of and the like should be intended as a non-exclusive relationship (i.e., with possible further variables involved), the term a/an should be intended as one or more items (unless expressly indicated otherwise), and the term means for (or any means-plus-function formulation) should be intended as any structure adapted or configured for carrying out the relevant function.

For example, an embodiment provides a method for certifying storage of tamper-evident data. However, the data may be of any type (for example, partial, different and additional data with respect to the ones mentioned above).

In an embodiment, the data are stored in one or more data structures. However, the data structures may be in any number each of any type (for example, with its data blocks arranged in the corresponding sequences via corresponding links defined by their digests, corresponding pointers and the like, via their position in files, databases and so on).

In an embodiment, the data structures are managed by one or more storage computing systems. However, the storage computing systems may be in any number and of any type (see below).

In an embodiment, each of the data structures contains a persistent sequence of data blocks. However, the data structure may comprise data blocks in any number and of any type (for example, with each data block containing the whole corresponding data, only a delta with respect to a previous block, a list of two or more sub-blocks and so on).

In an embodiment, the method comprises the following steps under the control of a certification computing system. However, the certification computing system may be of any type (see below).

In an embodiment, the method comprises storing (by the certification computing system) corresponding current digests of current versions of the data structures. However, the current digests may be of any type (for example, each defined by the Merkle tree root of the data blocks, by the hash value of a concatenation of the hash values of the data blocks, by the hash value of a concatenation of the data blocks and so on) and they may be stored in any way (for example, in a common database, in dedicated files and so on).

In an embodiment, the method comprises receiving (by the certification computing system) an appending request from a present one of the storage computing systems for appending a new one of the data blocks to a present one of the data structures. However, the appending request may be received in any way (for example, over an open communication channel, a protected communication channel and so on).

In an embodiment, the appending request comprises an indication of a new digest of a new version of the present data structure with the new data block appended thereto and a consistency proof for verifying without knowledge of the new data block that the new version of the present data structure contains the current version of the present data structure with no alteration and that the new version of the present data structure has been obtained by appending the new data block to the current version of the present data structure. However, the new digest may be indicated in any way (for example, comprised in the appending request, to be calculated from the consistency proof and so on) and the consistency proof may be of any type (for example, the Merkle consistency proof, the hash values of all the data blocks and so on); moreover, the appending request may comprise any additional information, down to none (for example, its digital signature, an inclusion proof of the new data block and so on).

In an embodiment, the method comprises verifying (by the certification computing system) the appending request comprising verifying that the current digest of the present data structure being calculated using the consistency proof matches the current digest of the present data structure stored in the certification computing system. However, the verification of the appending request may comprise any additional operation, down to none (for example, verifying that the new digest being calculated using the consistency proof matches the new digest comprised in the appending request, verifying the digital signature, an authorization to write the present data structure and so on).

In an embodiment, the method comprises, in response to a positive result of said verifying the appending request, updating (by the certification computing system) the current digest of the present data structure stored in the certification computing system to the new digest of the present data structure being obtained from the appending request satisfying the consistency proof. However, the new digest may be obtained in any way (for example, extracted from the appending request and verified to satisfy the consistency proof, calculated from the consistency proof and so on) and the current digest may be updated in any way (for example, by replacing its previous value, adding the new value to a list of all its previous values and so on).

In an embodiment, the method comprises, in response to a positive result of said verifying the appending request, returning (by the certification computing system) an indication of an appending receipt being certified by the certification computing system to the present storage computing system. However, the appending receipt may be of any type (for example, containing the appending request, only the new digest and the like, with or without a digital signature by the certification computing system, and so on) and its indication may be returned in any way (for example, actually transmitting the appending receipt back, making the appending receipt publicly available and so on).

In an embodiment, the appending receipt certifies the positive result of said verifying the consistency proof for authorizing said appending the new data block to the present data structure by the present storage computing system. However, this result may be achieved in any way (for example, by digitally signing the appending receipt by the certification computing system, by providing the appending receipt upon request by the certification computing system and so on).

Further embodiments provide additional advantageous features, which may however be omitted at all in a basic implementation.

In an embodiment, the method comprises receiving (by the certification computing system) the appending request comprising the new digest of the present data structure. However, this information may be missing (when the new digest may be calculated from the consistency proof).

In an embodiment, the method comprises verifying (by the certification computing system) the appending request further comprising verifying that the new digest of the present data structure being calculated using the consistency proof matches the new digest of the present data structure comprised in the appending request. However, the possibility is not excluded of using a consistency proof that only allows verifying the new digest without calculating it.

In an embodiment, the consistency proof is a Merkle consistency proof. However, the use is not excluded of a different consistency proof.

In an embodiment, the method comprises returning (by the certification computing system) the appending receipt being certified by the certification computing system with a digital signature of the appending request by the certification computing system. However, the digital signature in the appending receipt may be of any type (for example, obtained by calculating any hash value of the appending request, by encrypting the hash value or the appending request itself with any algorithm, and so on).

In an embodiment, the method comprises receiving (by the certification computing system) the appending request comprising a digital signature by the present storage computing system of the consistency proof of the present data structure. However, the digital signature in the appending request may be of any type (for example, relating to the new digest as well when present, either the same or different with respect to the one in the appending receipt).

In an embodiment, the method comprises verifying (by the certification computing system) the appending request comprising verifying the corresponding digital signature. However, the digital signature in the appending request may be verified in any way (for example, according to a corresponding digital certificate being comprised in the appending request or downloaded, and so on).

In an embodiment, the method comprises verifying (by the certification computing system) the appending request comprising verifying that the present storage computing system is authorized to write the present data structure. However, the authorization to write the present data structure may be verified in any way (for example, by means of an author list received at the creation of the data structure and possibly updated later on, a public register and so on).

In an embodiment, the method comprises receiving (by the certification computing system) a creation request from a further present one of the storage computing systems for creating a new one of the data structures. However, the creation request may be received in any way (for example, either the same or different with respect to the appending request) and it may be of any type (for example, a dedicated request, a first appending request with the current digest equal to a null value and so on).

In an embodiment, the creation request comprises an indication of an initial digest of an initial version of the new data structure. However, the initial digest may be indicated in any way (for example, actually comprised in the creation request, set to a default value and so on) and the creation request may comprise any additional information, down to none (for example, its digital signature, an author list of storage computing systems authorized to write the new data structure, an indication of the storage computing systems authorized to update the author list, such as identified by their digital certificates, host names, pairs of userID/password, and so).

In an embodiment, the method comprises initializing (by the certification computing system) the current digest of the new data structure stored in the certification computing system to the initial digest indicated in the creation request. However, the new data structure may be initialized with any additional operations, down to none (for example, saving the author list, publishing the corresponding information and so on).

In an embodiment, the method comprises returning (by the certification computing system) an indication of a creation receipt being certified by the certification computing system to the further present storage computing system. However, the creation receipt may be of any type (for example, containing the creation request, only the initial digest and the like, with or without a digital signature by the certification computing system, and so on) and its indication may be returned in any way (for example, either the same or different with respect to the appending request).

In an embodiment, the creation receipt certifies said initializing the current digest of the new data structure for authorizing said creating the new data structure by the further present storage computing system. However, this result may be achieved in any way (for example, either the same or different with respect to the appending receipt).

In an embodiment, the method comprises returning (by the certification computing system) the creation receipt being certified by the certification computing system with a digital signature of the creation request by the certification computing system. However, the digital signature in the creation receipt may be of any type (for example, either the same or different with respect to the one in the appending receipt).

An embodiment provides a method for storing tamper-evident data in one or more data structures. However, the data may be of any type and the data structures may be in any number (see above).

In an embodiment, the data structures are managed by one or more storage computing systems. However, the storage computing systems may be in any number and of any type (see below).

In an embodiment, each of the data structures contains a persistent sequence of data blocks. However, the data structure may comprise data blocks in any number and of any type (see above).

In an embodiment, the method comprises the following steps under the control of each of the storage computing systems.

In an embodiment, the method comprises generating (by the storage computing system) an appending request for appending a new one of the data blocks to a present data structure of the data structures being managed by the storage computing system. However, the data structures may be managed in any number and in any way by the storage computing system (for example, stored in the present storage computing system, in plain or cyphered form in a shared repository and so on).

In an embodiment, the appending request comprises an indication of a new digest of a new version of the present data structure with the new data block appended thereto and a consistency proof for verifying without knowledge of the new data block that the new version of the present data structure contains a current version of the present data structure with no alteration and that the new version of the present data structure has been obtained by appending the new data block to the current version of the present data structure. However, the appending request may be of any type (see above).

In an embodiment, the method comprises submitting (by the storage computing system) the appending request to a certification computing system storing corresponding current digests of current versions of the data structures. However, the appending request may be submitted in any way (see above).

In an embodiment, the method comprises receiving (by the storage computing system) an indication of an appending receipt being certified by the certification computing system in response to the appending request. However, the appending receipt may be received in any way (see above).

In an embodiment, the appending receipt certifies a positive result of verifying the appending request by the certification computing system comprising verifying that the current digest of the present data structure being calculated using the consistency proof matches the current digest of the present data structure stored in the certification computing system and that the new digest of the present data structure being obtained from the appending request satisfies the consistency proof. However, the appending receipt may be of any type and certifying any verification of the appending request (see above).

In an embodiment, the method comprises appending (by the storage computing system) the new data block to the local data structure in association with the corresponding appending receipt in response thereto. However, the appending receipt may be associated with the new data block in any way (for example, stored in a same record, in the same position in different lists, accessed in a separate structure via corresponding links and so on); in any case, the possibility is not excluded of storing the appending receipt in a different way (for example, in the certification computing system wherein it is available for downloading).

Further embodiments provide additional advantageous features, which may however be omitted at all in a basic implementation.

In an embodiment, the method comprises generating (by the storage computing system) the appending request comprising the new digest of the present data structure. However, this information may be missing (when the new digest may be calculated from the consistency proof).

In an embodiment, the method comprises receiving (by the storage computing system) the indication of the appending receipt certifying the positive result of verifying the appending request by the certification computing system further comprising verifying that the new digest of the present data structure being calculated using the consistency proof matches the new digest of the present data structure comprised in the appending request. However, the possibility is not excluded of using a consistency proof that only allows verifying the new digest without calculating it.

In an embodiment, the consistency proof is a Merkle consistency proof. However, the use is not excluded of a different consistency proof.

In an embodiment, the method comprises receiving (by the storage computing system) the appending receipt being certified by the certification computing system with a digital signature of the appending request by the certification computing system. However, the digital signature in the appending receipt may be of any type (see above).

In an embodiment, the method comprises generating (by the storage computing system) the appending request comprising a digital signature by the storage computing system of the consistency proof of the present data structure. However, the digital signature in the appending request may be of any type (see above).

In an embodiment, the method comprises generating (by the storage computing system) a creation request for creating a new data structure of the data structures being managed by the storage computing system, the creation request comprises an indication of an initial digest of an initial version of the new data structure. However, the creation request may be of any type (see above).

In an embodiment, the method comprises submitting (by the storage computing system) the creation request to the certification computing system. However, the creation request may be submitted in any way (see above).

In an embodiment, the method comprises receiving (by the storage computing system) an indication of a creation receipt being certified by the certification computing system in response to the creation request. However, the creation receipt may be received in any way (see above).

In an embodiment, the creation receipt certifies an initialization of the current digest of the new data structure stored in the certification computing system to the initial digest indicated in the creation request. However, the creation receipt may be of any type (see above).

In an embodiment, the method comprises creating (by the storage computing system) the new data structure in association with the creation receipt in response thereto. However, the new data structure may be created in any way (for example, with an initial record containing a null block, a dummy block providing the default initial digest and so on).

In an embodiment, the method comprises receiving (by the storage computing system) the creation receipt being certified by the certification computing system with a digital signature of the creation request by the certification computing system. However, the digital signature in the creation receipt may be of any type (see above).

In an embodiment, the method comprises transmitting (by the storage computing system) a mirroring notification for the new data block of the present data structure to corresponding one or more peer computing systems of the storage computing systems. However, the peer computing systems may be in any number (down to none) and indicated in any way (for example, in a peer list, a public register and so on); moreover, the mirroring notification may be transmitted in any way (for example, over point-to-point communication channels, broadcast, in clear/encrypted form and so on).

In an embodiment, the mirroring notification comprises the new data block and the corresponding appending receipt. However, the mirroring notification may comprise any additional information, down to none (for example, its digital signature by the storage computing system and so on).

In an embodiment, the method comprises receiving (by the storage computing system) a further mirroring notification for a further new one of the data blocks of the present data structure from one of the corresponding peer computing systems. However, the further mirroring notification may be of any type and received in any way (as the mirroring notification).

In an embodiment, the method comprises verifying (by the storage computing system) the further mirroring notification comprising verifying that the corresponding appending receipt has been certified by the certification computing system and verifying the corresponding consistency proof (said verifying the consistency proof of the further mirroring notification comprising verifying that the current digest of the present data structure being calculated using the consistency proof of the further mirroring notification matches the current digest of the present data structure stored in the storage computing system). However, the verification of the further mirroring notification may comprise any additional operations, down to none (for example, verifying that the new digest being calculated using the consistency proof matches the new digest comprised in the appending request, verifying a possible digital signature in the appending receipt, a possible digital signature in the appending request, an authorization to write the present data structure by the peer computing system and so on); in any case, the possibility is not excluded of simply verifying that the new digest of the present data structure with the further new data block appended thereto matches the new digest indicated in the further mirroring notification.

In an embodiment, the method comprises appending (by the storage computing system) the further new data block to the present data structure in association with the corresponding appending receipt in response to a positive result of said verifying the further mirroring notification. However, the further new data block and the corresponding appending receipt may be associated in any way (as above).

In an embodiment, the method comprises verifying (by the storage computing system) the further mirroring notification comprising verifying the digital signature in the corresponding appending receipt, verifying the digital signature in the corresponding appending request and verifying that the corresponding peer computing system is authorized to write the present data structure. However, the digital signatures and the authorization to write may be verified in any way (see above).

In an embodiment, the method comprises the following operations in response to a mismatch between the current digest of the present data structure being calculated using the consistency proof of the mirroring notification and the current digest of the present data structure stored in the storage computing system. However, the possibility is not excluded of verifying the current digest at any other time in addition to upon receiving the mirroring notification (for example, before submitting every appending request, after the refusal of any appending request or in response to any re-start of the storage computing system with respect to the value stored in the certification computing system, and so on).

In an embodiment, in response to the mismatch the method comprises submitting (by the storage computing system) a synchronization request to the peer computing systems of the present data structure. However, the synchronization request may be submitted in any way (for example, transmitted over point-to-point communication channels, broadcast and so on).

In an embodiment, the synchronization request comprises the current digest of the present data structure stored in the storage computing system. However, the synchronization request may comprise any additional information, down to none (for example, its digital signature, the expected value of the current digest of the present data structure as determined by the mirroring notification or received from the certification computing system, and so on).

In an embodiment, in response to the mismatch the method comprises receiving (by the storage computing system) a synchronization response to the synchronization request from at least one of the peer computing systems of the present data structure. However, the synchronization response may be received in any way (for example, considering only the first one, waiting for multiple ones, up to all, and considering the most up-to-date one, and so on).

In an embodiment, the synchronization response comprises a succession of one or more synchronization records each comprising a missing one of the data blocks being missing in the present data structure stored in the storage computing system and the corresponding appending receipt. However, the synchronization response may comprise any number of synchronization records (up to start from a first one with the creation receipt), each comprising any additional information, down to none (for example, its digital signature by the peer computing system, and so on).

In an embodiment, in response to the mismatch the method comprises verifying (by the storage computing system) the synchronization response comprising verifying the synchronization records along the succession of the synchronization response each comprising verifying that the corresponding appending receipt has been certified by the certification computing system and verifying the corresponding consistency proof, said verifying the consistency proof of the synchronization record comprising verifying that the current digest of the present data structure being calculated using the consistency proof of the synchronization record matches the current digest of the present data structure stored in the storage computing system if the synchronization record is a first one along the succession of the synchronization response or matches the new digest being obtained from a previous one of the records along the succession of the synchronization response satisfying the consistency proof otherwise. However, the verification of the synchronization response may comprise any additional operations, down to none (for example, verifying that the new digest being calculated using the consistency proof matches the new digest comprised in the appending request, verifying a possible digital signature in the appending receipt, a possible digital signature in the appending request, an authorization to write the present data structure and so on); in any case, the possibility is not excluded of simply verifying the new digests, only the new digest of a last synchronization record and so on.

In an embodiment, in response to the mismatch the method comprises appending (by the storage computing system) the missing data blocks along the succession of the synchronization response to the present data structure in association with the corresponding appending receipts in response to a positive result of said verifying the synchronization response. However, the missing data blocks and the corresponding appending receipts may be associated in any way (as above).

In an embodiment, the method comprises verifying (by the storage computing system) that the certification computing system is trusted to certify the appending receipts. However, the certification computing system may be verified in any way (for example, with a collaborative process, via a digital certificate proving that it belongs to an entity being generally trusted, such as a public authority, and so on).

In an embodiment, the method comprises distributing (by the storage computing system) one or more validation messages each comprising an indication of the succession of appending receipts of at least one of the data structures being managed by the storage computing system to the other storage computing systems. However, the sequence of appending receipts may be indicated in any way (for example, comprised in the validation messages, to be downloaded from the certification computing system and so on); moreover, the validation messages may comprise any additional information, down to none (for example, their digital signatures, the identifiers of the corresponding storage computing systems, their creation receipts and so on) and they may be distributed in any way (for example, in response to partial, different and additional events with respect to the ones mentioned above, for one or more selected data structures up to all of them, indirectly with a gossip protocol, directly by broadcasting them and so on).

In an embodiment, the method comprises receiving (by the storage computing system) one or more further validation messages each comprising an indication of the succession of appending receipts of at least one remote data structure of the data structures from the other storage computing systems. However, the appending receipts of the remote data structures may be distributed in any way (as above).

In an embodiment, the method comprises verifying (by the storage computing system) that the certification computing system is trusted comprising verifying each of the further validation messages, said verifying each of the further validation messages comprising verifying that the corresponding appending receipts have been certified by the certification computing system and verifying the consistency proof of each of the appending receipts different from a first one along the corresponding succession of the further validation message, said verifying the consistency proof of the further validation message comprising verifying that the current digest of the remote data structure being calculated using the consistency proof of the further validation message matches the new digest being obtained from the appending request of a previous one of the appending receipts along the succession of the validation message satisfying the corresponding consistency proof. However, the verification of each appending receipt may comprise any additional operations, down to none (for example, verifying that the new digest being calculated using the consistency proof matches the new digest comprised in the appending request, verifying its possible digital signatures, an authorization to write the remote data structure, a fork of the remote data structure, and so on).

In an embodiment, the method comprises verifying (by the storage computing system) that the certification computing system is trusted comprising verifying a consistency of the successions of appending receipts of the further validation messages of the remote data structure distributed by a plurality of the other storage computing systems. However, the further validation messages of the remote data structure may be distributed by any number of other storage computing systems and their consistency may be verified in any way (for example, detecting a fork whenever different successions are detected, when a succession differs from two or more other successions and so on).

In an embodiment, the method comprises outputting (by the storage computing system) an error message in response to a negative result of said verifying the certification computing system. However, the error message may be output in any way (for example, displayed or sent by e-mail, SMS, notification and the like to the administrator of the storage node, distributed to all the other storage nodes, made publicly available and so on) and it may have any content (for example, indicating a nature of the error, with or without the corresponding appending receipts and so on).

In an embodiment, the error message comprises an indication of corresponding one or more of the appending receipts of the further validation messages contributing to provide the negative result of said verifying the certification computing system. However, these appending receipts may be indicated in any way (for example, embedded in the error message, made accessible via a link and so on).

In an embodiment, the method comprises receiving (by the storage computing system) an auditing request for an audited one of the data structures being managed by the storage computing system from an auditor computing system. However, the auditing request may be received in any way (for example, either the same or different with respect to above) and from any auditor computing system (for example, a personal computer, a tablet, a smartphone and so on).

In an embodiment, the method comprises returning (by the storage computing system) an auditing response to the auditing computing system in response to the auditing request. However, the auditing response may be returned in any way (for example, either the same or different with respect to above).

In an embodiment, the auditing response comprises a succession of the creation receipt and one or more appending receipts for at least an initial part of the succession of data blocks of the audited data structure. However, the auditing response may relate to any initial part of the audited data structure (up to it completely, with or without the creation receipt) and it may comprise any additional information, down to none (for example, its digital signature by the storage computing system, and so on).

In an embodiment, this causes the auditing computing system to verify the auding response by verifying that the creation receipt of the auditing response has been certified by the certification computing system, verifying that each of the appending receipts of the auditing response has been certified by the certification computing system and verifying the corresponding consistency proof, said verifying the consistency proof of the auditing response comprising verifying that the current digest of the audited data structure being calculated using the consistency proof of the auditing response matches the initial digest comprised in the creation receipt of the auditing response if the appending receipt is a first one along the succession of the auditing response or matches the new digest being obtained from the appending request of a previous one of the appending receipts along the succession of the auditing response satisfying the corresponding consistency proof otherwise. However, the creation/appending receipts may be verified in any way (see above).

In an embodiment, this causes the auditing computing system to certify a consistency of the audited data structure in response to a positive result of said verifying the auding response. However, the consistency of the audited data structure may be certified in any way (for example, by digitally signing the auditing response, by a corresponding report and so on).

In an embodiment, the method comprises receiving (by the storage computing system) a sharing request for a shared one of the data structures being managed by the storage computing system from a user computing system. However, the sharing request may be received in any way (for example, either the same or different with respect to above) and from any user computing system (for example, a personal computer, a tablet, a smartphone and so on).

In an embodiment, the method comprises returning (by the storage computing system) a sharing response to the sharing computing system in response to the sharing request. However, the sharing response may be returned in any way (for example, either the same or different with respect to above).

In an embodiment, the sharing response comprises the creation receipt of the shared data structure, at least an initial part of the succession of data blocks of the shared data structure and the corresponding appending receipts. However, the sharing response may relate to any initial part of the shared data structure (up to it completely, with or without the creation receipt) and it may comprise any additional information, down to none (for example, its digital signature by the storage computing system, and so on).

In an embodiment, this causes the user computing system to verify the sharing response by verifying that the creation receipt of the sharing response has been certified by the certification computing system, verifying that each of the appending receipts of the sharing response has been certified by the certification computing system and verifying the corresponding consistency proof, said verifying the consistency proof of the sharing response comprising verifying that the current digest of the shared data structure being calculated using the consistency proof of the sharing response matches the initial digest comprised in the creation receipt of the sharing response if the appending receipt is a first one along the succession of the sharing response or matches the new digest being obtained from the appending request of a previous one of the appending receipts along the succession of the sharing response satisfying the consistency proof otherwise. However, the creation/appending receipts may be verified in any way (see above).

In an embodiment, this causes the sharing computing system to accept the data blocks of the sharing response in response to a positive result of said verifying the sharing response. However, the data blocks of the sharing response may be accepted in any way (for example, by storing them alone, in association with the corresponding creation/appending receipts and so on).

An embodiment provides a method for certifying storage of tamper-evident data in one or more data structures. In an embodiment, the method comprises storing (by a certification computing system) corresponding current digests of current versions of the data structures. In an embodiment, the method comprises generating (by each of one or more storage computing systems) an appending request for appending a new one of the data blocks to a present data structure of one or more of the data structures being managed by the storage computing system. In an embodiment, the appending request comprises an indication of a new digest of a new version of the present data structure with the new data block appended thereto and a consistency proof for verifying without knowledge of the new data block that the new version of the present data structure contains a current version of the present data structure with no alteration and that the new version of the present data structure has been obtained by appending the new data block to the current version of the present data structure. In an embodiment, the method comprises submitting (by the storage computing system) the appending request to the certification computing system. In an embodiment, the method comprises verifying (by the certification computing system) the appending request comprising verifying that the current digest of the present data structure being calculated using the consistency proof matches the current digest of the present data structure stored in the certification computing system. In an embodiment, the method comprises updating (by the certification computing system in response to a positive result of said verifying the appending request) the current digest of the present data structure stored in the certification computing system to the new digest of the present data structure being obtained from the appending request satisfying the consistency proof. In an embodiment, the method comprises returning (by the certification computing system in response to the positive result of said verifying the appending request) an indication of an appending receipts being certified by the certification computing system to the storage computing system, the appending receipt certifying the positive result of said verifying the consistency proof. In an embodiment, the method comprises appending (by the storage computing system) the new data block to the present data structure in association with the corresponding appending receipt in response thereto. However, the steps of the method may be implemented in any way as above and the method may comprise any one of the above-mentioned additional step.

Generally, similar considerations apply if the same solution is implemented with equivalent methods (by using similar steps with the same functions of more steps or portions thereof, removing some non-essential steps or adding further optional steps); moreover, the steps may be performed in a different order, concurrently or in an interleaved way (at least in part).

An embodiment provides a computer program configured for causing a corresponding computing system to perform each of the methods of above when the computer program is executed on the computing system. An embodiment provides a computer program product, the computer program product comprising one or more computer readable storage media having program instructions collectively stored on the readable storage media, the program instructions readable by a computing system to cause the computing system to perform the same method. However, each (software) program may be of any type (for example, implemented as a stand-alone module, as a plug-in for a pre-existing software program, such as a certification manager and a storage manager of the certification computing system and of the storage computing system, respectively, directly in the latter and so on) and it may be used on any computing system (see below). It would be readily apparent that it is also possible to deploy the same solution as a service that is accessed through a network (such as in the Internet).

Generally, similar considerations apply if the program is structured in a different way, or if additional modules or functions are provided; likewise, the memory structures may be of other types, or may be replaced with equivalent entities (not necessarily consisting of physical storage media). The program may take any form suitable to be used by any computing system, thereby configuring the computing system to perform the desired operations; particularly, the program may be in the form of external or resident software, firmware, or microcode (either in object code or in source code), for example, to be compiled or interpreted. Moreover, it is possible to provide the program on any computer readable storage medium. The storage medium is any tangible medium (different from transitory signals per se) that may retain and store instructions for use by the computing system. For example, the storage medium may be of the electronic, magnetic, optical, electromagnetic, infrared, or semiconductor type; examples of such storage medium are fixed disks (where the program may be pre-loaded), removable disks, memory keys (for example, USB), and the like. The program may be downloaded to the computing system from the storage medium or via a network (for example, the Internet, a wide area network and/or a local area network comprising transmission cables, optical fibers, wireless connections, network devices); one or more network adapters in the computing system receive the program from the network and forward it for storage into one or more storage devices of the computing system. In any case, the solution according to an embodiment of the present disclosure lends itself to be implemented even with a hardware structure (for example, by electronic circuits integrated on one or more chips of semiconductor material), or with a combination of software and hardware suitably programmed or otherwise configured.

An embodiment provides a certification computing system comprising means configured for performing the steps of the corresponding method of above. An embodiment provides a certification computing system comprising a circuitry (i.e., any hardware suitably configured, for example, by software) for performing each step of the same method. An embodiment provides a storage computing system comprising means configured for performing the steps of the corresponding method of above. An embodiment provides a storage computing system comprising a circuitry (i.e., any hardware suitably configured, for example, by software) for performing each step of the same method. However, the certification/storage computing system may be of any type (for example, implemented by a physical machine, a virtual machine, a cloud service and so on).

An embodiment provides a computing infrastructure comprising the certification computing system and one or more storage computing systems as above. However, the infrastructure may have a different architecture (for example, based on a global, local or wide area network, exploiting any type of wired and/or wireless connections, such as of metal wire, optical fiber, Wi-fi, mobile telephone or satellite type, and so on). However, its implementation by virtual machines running on a same physical machine is not excluded.

Generally, similar considerations apply if the certification computing system, the storage computing system and the computing infrastructure each has a different structure, comprises equivalent components or it has other operative characteristics. In any case, every component thereof may be separated into more elements, or two or more components may be combined together into a single element; moreover, each component may be replicated to support the execution of the corresponding operations in parallel. Moreover, unless specified otherwise, any interaction between different components generally does not need to be continuous, and it may be either direct or indirect through one or more intermediaries.

1. A method for certifying storage of tamper-evident data in one or more data structures managed by one or more storage computing systems, each of the data structures containing a persistent sequence of data blocks, wherein the method comprises, under the control of a certification computing system:
storing, by the certification computing system, corresponding current digests of current versions of the data structures,
receiving, by the certification computing system, an appending request from a present one of the storage computing systems for appending a new one of the data blocks to a present one of the data structures, the appending request comprising an indication of a new digest of a new version of the present data structure with the new data block appended thereto and a consistency proof for verifying without knowledge of the new data block that the new version of the present data structure contains the current version of the present data structure with no alteration and that the new version of the present data structure has been obtained by appending the new data block to the current version of the present data structure,
verifying, by the certification computing system, the appending request comprising verifying that the current digest of the present data structure being calculated using the consistency proof matches the current digest of the present data structure stored in the certification computing system, and
in response to a positive result of said verifying the appending request:
updating, by the certification computing system, the current digest of the present data structure stored in the certification computing system to the new digest of the present data structure being obtained from the appending request satisfying the consistency proof, and
returning, by the certification computing system, an indication of an appending receipt being certified by the certification computing system to the present storage computing system , the appending receipt certifying the positive result of said verifying the consistency proof for authorizing said appending the new data block to the present data structure by the present storage computing system.

2. The method according to claim 1, wherein the method comprises:
receiving, by the certification computing system, the appending request comprising the new digest of the present data structure, and
verifying, by the certification computing system, the appending request further comprising verifying that the new digest of the present data structure being calculated using the consistency proof matches the new digest of the present data structure comprised in the appending request.

3. The method according to claim 1, wherein the consistency proof is a Merkle consistency proof.

4. (canceled)

5. The method according to claim 1, wherein the method comprises:
receiving, by the certification computing system, the appending request comprising a digital signature by the present storage computing system of the consistency proof of the present data structure, and
verifying, by the certification computing system, the appending request comprising verifying the corresponding digital signature and that the present storage computing system is authorized to write the present data structure.

6. The method according to claim 1, wherein the method comprises:
receiving, by the certification computing system, a creation request from a further present one of the storage computing systems for creating a new one of the data structures, the creation request comprising an indication of an initial digest of an initial version of the new data structure,
initializing, by the certification computing system, the current digest of the new data structure stored in the certification computing system to the initial digest indicated in the creation request, and
returning, by the certification computing system, an indication of a creation receipt being certified by the certification computing system to the further present storage computing system, the creation receipt certifying said initializing the current digest of the new data structure for authorizing said creating the new data structure by the further present storage computing system.

7. (canceled)

8. A method for storing tamper-evident data in one or more data structures managed by one or more storage computing systems, each of the data structures containing a persistent sequence of data blocks, wherein the method comprises, under the control of each of the storage computing systems:
generating, by the storage computing system, an appending request for appending a new one of the data blocks to a present data structure of the data structures being managed by the storage computing system, the appending request comprising an indication of a new digest of a new version of the present data structure with the new data block appended thereto and a consistency proof for verifying without knowledge of the new data block that the new version of the present data structure contains a current version of the present data structure with no alteration and that the new version of the present data structure has been obtained by appending the new data block to the current version of the present data structure,
submitting, by the storage computing system, the appending request to a certification computing system storing corresponding current digests of current versions of the data structures,
receiving, by the storage computing system, an indication of an appending receipt being certified by the certification computing system in response to the appending request, the appending receipt certifying a positive result of verifying the appending request by the certification computing system comprising verifying that the current digest of the present data structure being calculated using the consistency proof matches the current digest of the present data structure stored in the certification computing system and that the new digest of the present data structure being obtained from the appending request satisfies the consistency proof, and
appending, by the storage computing system, the new data block to the present data structure in association with the corresponding appending receipt in response thereto.

9. The method according to claim 8, wherein the method comprises:
generating, by the storage computing system, the appending request comprising the new digest of the present data structure, and
receiving, by the storage computing system, the indication of the appending receipt certifying the positive result of verifying the appending request by the certification computing system further comprising verifying that the new digest of the present data structure being calculated using the consistency proof matches the new digest of the present data structure comprised in the appending request.

10. The method according to claim 8, wherein the consistency proof is a Merkle consistency proof.

11-12. (canceled)

13. The method according to claim 8, wherein the method comprises:
generating, by the storage computing system, a creation request for creating a new data structure of the data structures being managed by the storage computing system, the creation request comprising an indication of an initial digest of an initial version of the new data structure,
submitting, by the storage computing system, the creation request to the certification computing system,
receiving, by the storage computing system, an indication of a creation receipt being certified by the certification computing system in response to the creation request, the creation receipt certifying an initialization of the current digest of the new data structure stored in the certification computing system to the initial digest indicated in the creation request, and
creating, by the storage computing system, the new data structure in association with the creation receipt in response thereto.

14. (canceled)

15. The method according to claim 8, wherein the method comprises:
transmitting, by the storage computing system, a mirroring notification for the new data block of the present data structure to corresponding one or more peer computing systems of the storage computing systems, the mirroring notification comprising the new data block and the corresponding appending receipt,
receiving, by the storage computing system, a further mirroring notification for a further new one of the data blocks of the present data structure from one of the corresponding peer computing systems,
verifying, by the storage computing system, the further mirroring notification comprising verifying that the corresponding appending receipt has been certified by the certification computing system and verifying the corresponding consistency proof, said verifying the consistency proof of the further mirroring notification comprising verifying that the current digest of the present data structure being calculated using the consistency proof of the further mirroring notification matches the current digest of the present data structure stored in the storage computing system, and
appending, by the storage computing system, the further new data block to the present data structure in association with the corresponding appending receipt in response to a positive result of said verifying the further mirroring notification.

16. The method according to claim 15, wherein the method comprises:
receiving, by the storage computing system, the appending receipt being certified by the certification computing system with a digital signature of the appending request by the certification computing system,
generating, by the storage computing system, the appending request comprising a digital signature by the storage computing system of the consistency proof of the present data structure, and
verifying, by the storage computing system, the further mirroring notification comprising verifying the digital signature in the corresponding appending receipt, verifying the digital signature in the corresponding appending request and verifying that the corresponding peer computing system is authorized to write the present data structure.

17. The method according to claim 15, wherein the method comprises, in response to a mismatch between the current digest of the present data structure being calculated using the consistency proof of the mirroring notification and the current digest of the present data structure stored in the storage computing system:
submitting, by the storage computing system, a synchronization request to the peer computing systems of the present data structure, the synchronization request comprising the current digest of the present structure stored in the storage computing system,
receiving, by the storage computing system, a synchronization response to the synchronization request from at least one of the peer computing systems of the present data structure, the synchronization response comprising a succession of one or more synchronization records each comprising a missing one of the data blocks being missing in the present data structure stored in the storage computing system and the corresponding appending receipt,
verifying, by the storage computing system, the synchronization response comprising verifying the synchronization records along the succession of the synchronization response each comprising verifying that the corresponding appending receipt has been certified by the certification computing system and verifying the corresponding consistency proof, said verifying the consistency proof of the synchronization record comprising verifying that the current digest of the present data structure being calculated using the consistency proof of the synchronization record matches the current digest of the present data structure stored in the storage computing system if the synchronization record is a first one along the succession of the synchronization response or matches the new digest being obtained from the appending request of a previous one of the synchronization records along the succession of the synchronization response satisfying the consistency proof otherwise, and
appending, by the storage computing system, the missing data blocks along the succession of the synchronization response to the present data structure in association with the corresponding appending receipts in response to a positive result of said verifying the synchronization response.

18. (canceled)

19. The method according to claim 8, wherein the method comprises:
distributing, by the storage computing system, one or more validation messages each comprising an indication of the succession of appending receipts of at least one of the data structures being managed by the storage computing system to the other storage computing systems,
receiving, by the storage computing system, one or more further validation messages each comprising an indication of the succession of appending receipts of at least one remote data structure of the data structures being distributed by the other storage computing systems,
verifying, by the storage computing system, that the certification computing system is trusted to certify the appending receipts comprising verifying each of the further validation messages, said verifying each of the further validation messages comprising verifying that the corresponding appending receipts have been certified by the certification computing system and verifying the consistency proof of each of the appending receipts different from a first one along the corresponding succession of the further validation message, said verifying the consistency proof of the further validation message comprising verifying that the current digest of the remote data structure being calculated using the consistency proof of the further validation message matches the new digest being obtained from the appending request of a previous one of the appending receipts along the succession of the validation message satisfying the corresponding consistency proof.

20. The method according to claim 19, wherein the method comprises:
verifying, by the storage computing system, that the certification computing system is trusted further comprising verifying a consistency of the successions of appending receipts of the further validation messages of the remote data structure distributed by a plurality of the other storage computing systems.

21. (canceled)

22. The method according to claim 13, wherein the method comprises:
receiving, by the storage computing system, an auditing request for an audited one of the data structures being managed by the storage computing system from an auditor computing system, and
returning, by the storage computing system, an auditing response to the auditing computing system in response to the auditing request, the auditing response comprising a succession of the creation receipt and one or more appending receipts for at least an initial part of the succession of data blocks of the audited data structure, for causing the auditing computing system to:
verify the auding response by verifying that the creation receipt of the auditing response has been certified by the certification computing system, verifying that each of the appending receipts of the auditing response has been certified by the certification computing system and verifying the corresponding consistency proof, said verifying the consistency proof of the auditing response comprising verifying that the current digest of the audited data structure being calculated using the consistency proof of the auditing response matches the initial digest comprised in the creation receipt of the auditing response if the appending receipt is a first one along the succession of the auditing response or matches the new digest being obtained from the appending request of a previous one of the appending receipts along the succession of the auditing response satisfying the corresponding consistency proof otherwise, and
certify a consistency of the audited data structure in response to a positive result of said verifying the auding response.

23. The method according to claim 13, wherein the method comprises:
receiving, by the storage computing system, a sharing request for a shared one of the data structures being managed by the storage computing system from a user computing system,
returning, by the storage computing system, a sharing response to the user computing system in response to the sharing request, the sharing response comprising the creation receipt of the shared data structure, at least an initial part of the succession of data blocks of the shared data structure and the corresponding appending receipts, for causing the user computing system to:
verify the sharing response by verifying that the creation receipt of the sharing response has been certified by the certification computing system, verifying that each of the appending receipts of the sharing response has been certified by the certification computing system and verifying the corresponding consistency proof, said verifying the consistency proof of the sharing response comprising verifying that the current digest of the shared data structure being calculated using the consistency proof of the sharing response matches the initial digest comprised in the creation receipt of the sharing response if the appending receipt is a first one along the succession of the sharing response or matches the new digest being obtained from the appending request of a previous one of the appending receipts along the succession of the sharing response satisfying the corresponding consistency proof otherwise, and
accept the data blocks of the sharing response in response to a positive result of said verifying the sharing response.

24-25. (canceled)

26. A computer program product comprising one or more computer readable storage media having program instructions collectively stored on the readable storage media, the program instructions readable by a certification computing system to cause the certification computing system to perform the method according to claim 1.

27. (canceled)

28. A certification computing system comprising a circuitry for performing each step of the method according to claim 1.

29. (canceled)

30. A storage computing system comprising a circuitry for performing each step of the method according to claim 8.

31. (canceled)

32. A computer program product comprising one or more computer readable storage media having program instructions collectively stored on the readable storage media, the program instructions readable by a storage computing system to cause the storage computing system to perform the method according to claim 8.
